(19) United States
(12) Patent Application Publication
(10) Pub. No.: US 2015/0099137 A1
(43) Pub. Date: Apr. 9, 2015

(54) BASE FRAME

(71) Applicants: Inventec (Pudong) Technology Corporation, Shanghai (CN); INVENTEC CORPORATION, Taipei City (TW)

(72) Inventors: Chun-Ying YANG, TAIPEI CITY (TW); Chi-Cheng HSIAO, TAIPEI CITY (TW); Ying-Chao PENG, TAIPEI CITY (TW)

(73) Assignees: INVENTEC CORPORATION, Taipei City (TW); Inventec (Pudong) Technology Corporation, Shanghai (CN)

(21) Appl. No.: 14/226,810

(22) Filed: Mar. 26, 2014

(30) Foreign Application Priority Data
Oct. 9, 2013 (CN) 201310467131.6

(51) Int. Cl. B32B 15/01

(52) U.S. Cl. CPC B32B 15/01
USPC 428/596

(57) ABSTRACT

A base frame includes a base plate, a first side plate, and a second side plate. The base plate has a first edge and a second edge. The base plate includes a plurality of V-shaped reinforcing ribs. Each V-shaped reinforcing rib has a first end and a second end. The first and second ends are located at the first and second edges, respectively. The first side plate is connected to the first edge and has a plurality of first through holes. Each first through hole is locationally configured next to the first edge and faces to the corresponding first end. The second side plate is connected to the second edge and has a plurality of second through holes. Each second through hole is locationally configured next to the second edge and faces to the corresponding second end.

### RELATED APPLICATIONS

This application claims priority to Chinese Application Serial Number 201310467131.6, filed Oct. 9, 2013, which is herein incorporated by reference.

### BACKGROUND

1. Technical Field

The present invention relates to a base frame. More particularly, the present invention relates to a base frame which is made from metal plate and subjected to metal bending process.

2. Description of Related Art

While sheet metal is subjected to metalworking, reinforcing ribs and supplemental ribs are formed at the sheet metal to enhance strength of material. However, while a workpiece is formed at the sheet metal or bonded to the sheet metal by riveting process, the sheet metal is vulnerable to downforce due to the workpiece or force due to riveting process. Thus, the sheet metal will sag and be deformed toward a specific direction. Sagging or deformation of the sheet metal results in inconvenience while operators of production line want to assemble other parts at the sheet metal. For example, if computer cases are deformed or sag, components such as printed circuit boards cannot be securely installed at the cases so that components such as printed circuit boards may be damaged by deformed computer cases.

To prevent the sheet metal from being damaged, it is usually to enhance structure strength of the sheet metal, make modification to die design and die molding. In addition, the sheet metal is also prevented from damaged through strict quality control. However, the foregoing solutions cause either cost increase or analytical cost and die-manufacturing cost.

### SUMMARY

A base frame includes a base plate, a first side plate, and a second side plate. The base plate has a first edge and a second edge opposite to each other. The base plate includes a plurality of V-shaped reinforcing ribs. Each of the V-shaped reinforcing ribs has a first end and a second end. The first end is located at the first edge, and the second end is located at the second edge. The first side plate is connected to the first edge and has a plurality of first through holes. Each of the first through holes is locationally configured next to the first edge and faces to the first end of the corresponding V-shaped reinforcing db. The second side plate is connected to the second edge and has a plurality of second through holes. Each of the second through holes is locationally configured next to the second edge and faces to the second end of the corresponding V-shaped reinforcing rib.

According to the present invention, the foregoing base plate has an inner surface. The V-shaped reinforcing ribs protuberate from the inner surface.

According to the present invention, each of the foregoing V-shaped reinforcing ribs has a protruding peak line which is a straight line.

According to the present invention, the protruding peak lines are parallel.

According to the present invention, the foregoing protruding peak lines are perpendicular to the first side plate and the second side plate.

According to the present invention, the foregoing protruding peak lines are apart from the base plate by an equal distance.

According to the present invention, each of the foregoing V-shaped reinforcing ribs is a stamping forming structure on the base plate.

According to the present invention, a width of each of the first through holes is equal to a width of the corresponding V-shaped reinforcing rib, and a width of each of the second through holes is equal to a width of the corresponding V-shaped reinforcing rib.

In summary, the present invention provides a base frame having a plurality reinforcing ribs at the base plate. Each of the reinforcing ribs has two ends extending toward the two edges so that the base plate has a flat surface. Besides, each of the reinforcing ribs has a V-shaped profile so the base plate has a flat surface and enough space. Thus, the base plate has greater structure strength and supporting force.

These and other features, aspects, and advantages of the present invention will become better understood with reference to the following description and appended claims.

### BRIEF DESCRIPTION OF THE DRAWINGS

The invention can be more fully understood by reading the following detailed description of the embodiment, with reference made to the accompanying drawings as folio

FIG. 1 is a perspective view of a base frame according to one embodiment of the present invention;

FIG. 2 is a partial perspective view with an edge removed of the base frame of FIGS. 1; and

FIG. 3 is a partial top view of the base frame of FIG. 1.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

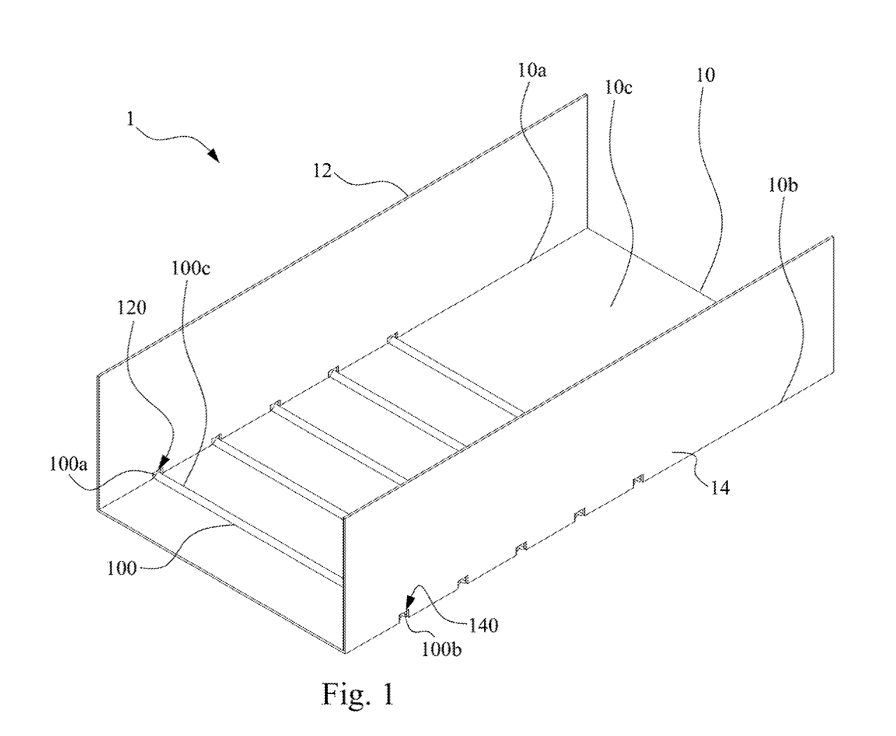

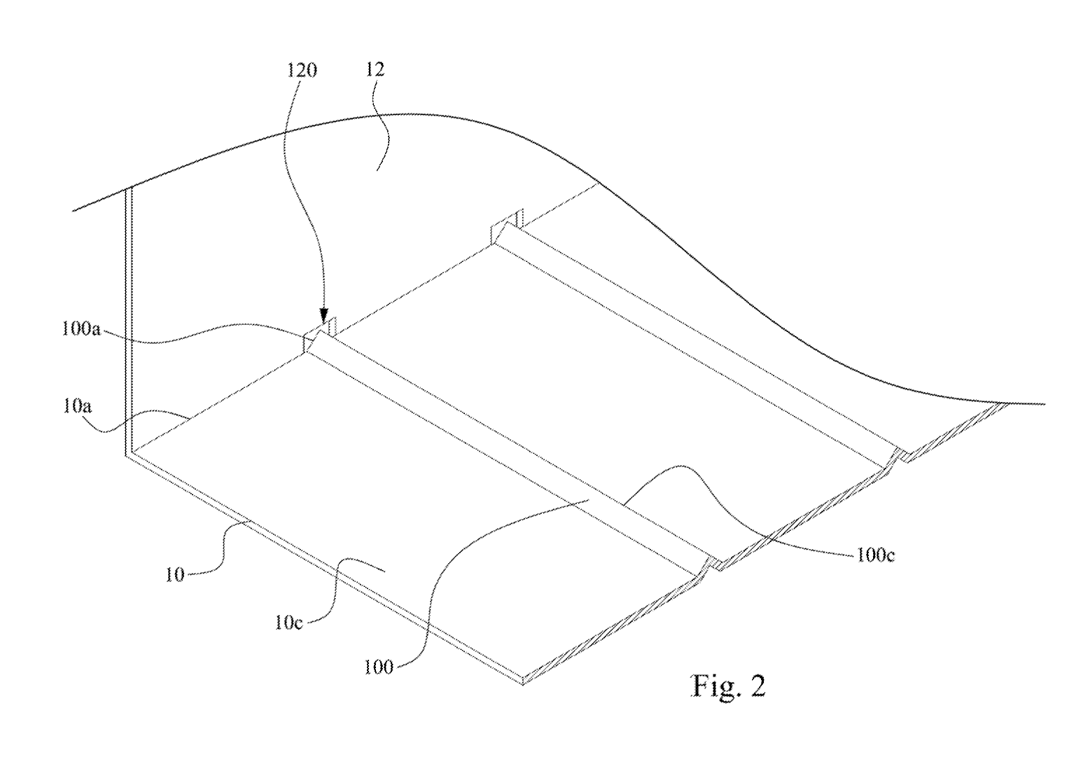

FIG. 1 illustrates a perspective view of a base frame 1 according to one embodiment of the present invention. FIG. 2 illustrates a partial perspective view with an edge removed of the base frame 1 of FIG. 1.

As shown in FIGS. 1 and 2, according to the embodiment, the base frame 1 may be part of server case (not shown) for supporting components (not shown) within the server case. For example, 2.5-inch Small Form Factor (SSF) storage device or 3.5-inch. Large Form Factor (LFF) storage device. However, the present invention is not limited to these applications. The base frame 1 of the present invention may be implemented within the server (e.g. blade series servers) to supports internal components.

As shown in FIGS. 1 and 2, according to the embodiment, the base frame 1 includes a base plate 10, a first side plate 12, and a second side plate 14. The base plate 10 of the base frame 1 has a first edge 10a and a second edge 10b. The first edge 10a and the second edge 10b are opposite each other and parallel. The base plate 10 of the base frame 1 includes a plurality of V-shaped reinforcing ribs 100. Each of the V-shaped reinforcing ribs 100 of the base plate 10 has a first end 100a and a second end 100b. The first end 100a of each of the V-shaped reinforcing ribs 100 is located at the first edge 10a of the base plate 10. The second end 100b of each of the V-shaped reinforcing ribs 100 is located at the second edge 10b of the base plate 10.

That is, the first end 100a and the second end 100b of each of the V-shaped reinforcing ribs 100 respectively extend toward the first edge 10a and the second edge 10b of the base plate 10 so that the base plate 10 has a surface with great flatness.

The first side plate 12 of the base frame 1 is connected with the first edge 10a of the base plate 10 and has a plurality of first through holes 120. Each of the first through holes 120 of the first side plate 12 is locationally configured next to the first edge 1 0a of the base frame 1 and corresponds to the first end 100a of the V-shaped reinforcing ribs 100. The second side plate 14 of the base frame 1 is connected with the second edge 10b of the base plate 10 and has a plurality of second through holes 140. Each of the second through holes 140 of second side plate 14 is locationally configured next to the second edge 10b of the base frame 1 and corresponds to the second end 100b of the V-shaped reinforcing ribs 100.

As shown in FIG. 1, in a direction that is parallel to the base plate 10 and the first side plate 12, a width of each of the first through holes 120 is equal to a width of the corresponding V-shaped reinforcing rib 100. Similarly, in a direction that is parallel to the base plate 10 and the second side plate 14, a width of each of the second through holes 140 is equal to a width of the corresponding V-shaped reinforcing rib 100.

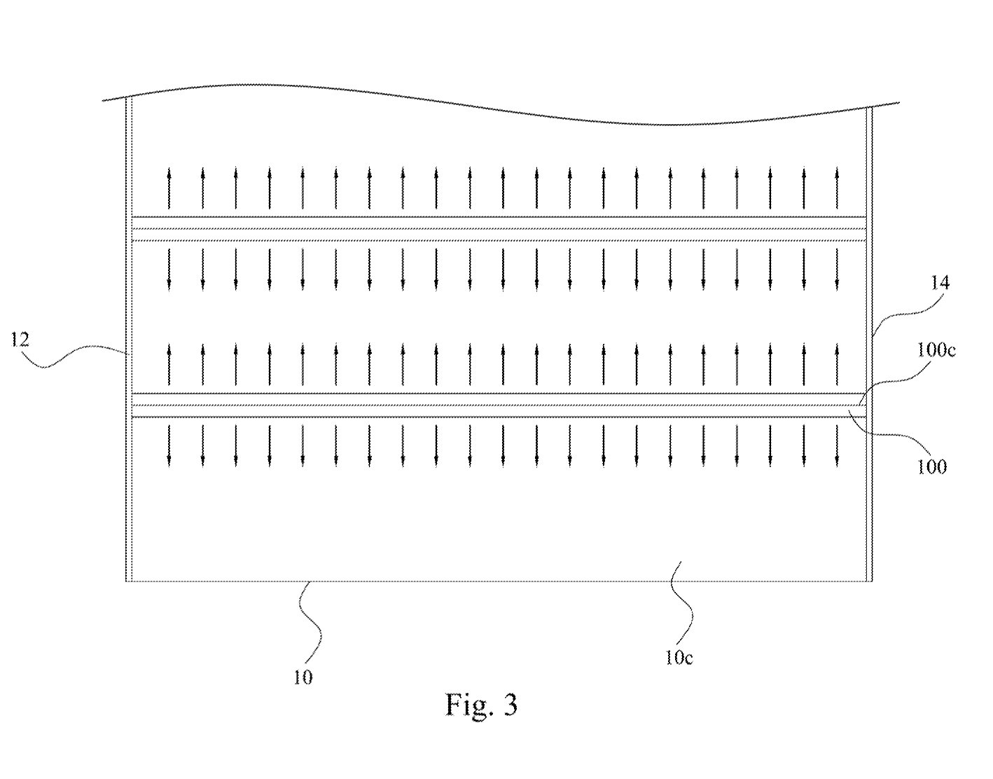

FIG. 3 illustrates a partial top view of the base frame 1 of FIG. 1.

As shown in FIGS. 1-3, according to the embodiment, the base plate 10 of the base frame 1 has an inner surface 10c. The first side plate 12 and the second side plate 14 of the base frame 1 are respectively bent from the first edge 10a and the second edge 10b of the base plate 10 toward the inner surface 10c of the base plate 10 and perpendicular to the inner surface 10c. The V-shaped reinforcing ribs 100 of the base plate 10 protrude from the inner surface 10c, and each of the V-shaped reinforcing ribs 100 of the base plate 10 has a protruding peak line 100c, Each of the protruding peak line 100c is a straight line. The protruding peak lines 100c of the base plate 10 are parallel, and perpendicular to the first side plate 12 and the second side plate 14 of the base frame 1. The protruding peak lines 100c are apart from the base plate 10 by an equal distance.

Therefore, if the protruding peak lines 100c forma virtual supporting plane (not shown), then the base plate 10 may flatly support an object (not shown) by the protruding peak lines 100c of the V-shaped reinforcing ribs 100. Compared to conventional arc-shaped or rectangular reinforcing ribs, the present invention provides V-shaped reinforcing ribs 100 to make the base plate flat and enough space. Besides, the base plate has greater structure strength and supporting force.

As shown in FIG. 3, the first end 100a and the second end 100b of each of the V-shaped reinforcing ribs 100 extend to the first edge 10a and the second edge 10b of the base plate 10 respectively. Because the protruding peak lines 100c are straight lines and parallel each other, shear stress flow is directed to a direction perpendicular to the protruding peak line 100c. Even though the base plate 10 is deformed because it supports an object, the base plate 10 is deformed along the same direction and has the same shear strain. Thus, the base plate 10 has a surface with great flatness.

According to the embodiment, each of the V-shaped reinforcing ribs 100 is a stamping forming structure formed at the base plate 10.

According to the embodiment, a plurality of V-shaped reinforcing ribs 100, first through holes 120, and second through holes 140 are formed at the base frame 1 by stamping forming process in advance. Each of the first through holes 120 is adjacent to and corresponds to one of the first ends 100a of the V-shaped reinforcing ribs 100. Each of the second through holes 140 is adjacent to and corresponds to one of the second ends 100b of the V-shaped reinforcing ribs 100. The metal plate is bent along the first ends 100a and the second end 100b of the V-shaped reinforcing ribs 100 so that the base plate 10, the first side plate 12, and the second side plate 14 are formed. The first edge 10a and the second edge 10b of the base plate 10 are where the metal plate is bent and subjected to metalworking. In addition, each of the first through holes 120 is defined at the first side plate 12 and corresponds to one of the first end 100a of the V-shaped reinforcing ribs 100. Each of the second through holes 140 is defined at the second side plate 14 and corresponds to one of the second end 100b of the V-shaped reinforcing ribs 100.

It is noted that the first through holes 120 of the first side plate 12 and the second through holes 140 of the second side plate 14 are respectively in vicinity with the first ends 100a and the second ends 100b of the V-shaped reinforcing ribs 100. Neither the first side plate 12 nor the second side plate 14 is not directly connected with the V-shaped reinforcing ribs 100. While the V-shaped reinforcing ribs 100 is subjected to an object, shear stress flow from the V-shaped reinforcing ribs 100 does not directly have impact on the first side plate 12 and the second side plate 14. Thus, the first side plate 12 and the second side plate 14 with respect to the base plate 10 will not be slightly deformed toward outside.

As mentioned above, it is understood that the base frame of the present invention has a plurality of V-shaped reinforcing ribs at the base plate, and each of the V-shaped reinforcing ribs extends toward both ends of the base plate so the base plate has a flat surface and enough space. Thus, the base plate has greater structure strength and supporting force.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A base frame, comprising:
a base plate having a first edge and a second edge opposite to each other and having a plurality of V-shaped reinforcing ribs, and each of V-shaped reinforcing ribs having a first end located at the first edge and a second end located at the second edge;
a first side plate connected to the first edge and having a plurality of first through holes, wherein each of the first through holes is locationally configured next to the first edge and faces to the first end of one of the corresponding V-shaped reinforcing ribs; and
a second side plate connected to the second edge and having a plurality of second through holes, wherein each of the second through holes is locationally configured next to the second edge and faces to the second end of one of the corresponding V-shaped reinforcing ribs.

2. The base frame of claim 1, wherein the base plate has an inner surface, the V-shaped reinforcing ribs protuberate from the inner surface.

3. The base frame of claim 2, wherein each of the V-shaped reinforcing ribs has a protruding peak line which is a straight line.

4. The base frame of claim 3, wherein the protruding peak lines are parallel.

5. The base frame of clan 4, wherein the protruding peak lines are perpendicular to the first side plate and the second side plate.

6. The base frame of claim 3, wherein the protruding peak lines are apart from the base plate by an equal distance.

7. The base frame of claim 1, wherein each of the V-shaped reinforcing ribs is a stamping forming structure on the base plate.

8. The base frame of claim 1, wherein a width of each of the first through holes is equal to a width of the corresponding V-shaped reinforcing rib, and a width of each of the second through holes is equal to a width of the corresponding V-shaped reinforcing rib.
